(19) United States
(12) Patent Application Publication
(10) Pub. No.: US 2006/0021013 A1
(43) Pub. Date: Jan. 26, 2006

(54) Method of transmitting data

(75) Inventor: Mitsuhiro Kinoshita, Mishima-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 10/889,990

(22) Filed: Jul. 12, 2004

(51) Int. Cl. H04L 9/32

(52) U.S. Cl. 726/6

(57) ABSTRACT

When a transmission operation is started, a CPU checks whether a department management state is set. Based on a department management code and a department management password that are input when the department management state is set, the CPU checks coincidence/noncoincidence of a department management password that corresponds to a department management code stored in a RAM. If the coincidence of the department management password is determined, the CPU opens an address book that is registered in the RAM. In this case, if a security mode that is set in the RAM is in an “ON” state, the CPU effects display of only address information that is linked to the associated department management code. If the displayed address information is selected, the CPU controls a transmission operation based on the selected address information.

### BACKGROUND OF THE INVENTION

1. Field of the Invention

The present invention relates to a data transmission method for a communication terminal apparatus and a data transmission method for an image forming apparatus, wherein information such as image data in a communication terminal apparatus, such as an image forming apparatus, which has a communication function, is transmitted.

2. Description of the Related Art

In recent years, from the standpoint of information security, there has been proposed a digital multi-function peripheral (MFP) with a function of preventing leakage of a confidential document due to a theft of a hard disk drive (HDD) by encrypting image data stored in the hard disk drive in the MFP.

Also proposed is an MFP that is provided with a settable mode, i.e. a security mode, which is set “ON” to execute a function for tightening a password access control for a confidential document.

In an MFP with a communication function, address information, such as a customer's telephone number or e-mail address, can be registered. In some cases, such address information is important customer information for some users. Besides, a transmission/reception history of a facsimile (FAX) or an Internet facsimile may possibly be important secret information.

However, the address information or communication history information is freely accessible, that is, read out or rewritten, from the client side through an operation unit of the MFP or via a network. This poses a serious problem relating to security.

### BRIEF SUMMARY OF THE INVENTION

The object of an aspect of the present invention is to provide a data transmission method for a communication terminal apparatus and a data transmission method for an image forming apparatus, wherein security of customer address information and communication history information can be ensured in a communication terminal apparatus, such as an image forming apparatus, which has a communication function.

According to an aspect of the present invention, there is provided a method of transmitting data for a communication terminal apparatus that is connected to a plurality of terminal devices and has a function of transmitting data to the terminal devices, the method comprising: assigning a management code to each of transmission data that are to be transmitted to the plurality of terminal devices, and pre-registering a management password corresponding to the management code; confirming a management state of the registered transmission data when the data is to be transmitted from the communication terminal apparatus; determining coincidence/noncoincidence between the registered management password corresponding to the management code and a management code and a management password that are input when the transmission data is in the management state; reading out the registered transmission data when the coincidence is determined; displaying the transmission data alone, to which the input management code is assigned, when a security mode is preset for the read-out transmission data; and executing a transmission control on the basis of the transmission data that is selected from the displayed transmission data.

According to another aspect of the present invention, there is provided a method of transmitting data for an image forming apparatus that is connected to a plurality of terminal devices and has a function of transmitting image data to the terminal devices, the method comprising: assigning a management code to each of transmission data that are to be transmitted to the plurality of terminal devices, and pre-registering a management password corresponding to the management code; confirming a management state of the registered, transmission data when the image data is to be transmitted from the image forming apparatus; determining coincidence/noncoincidence between the registered management password corresponding to the management code and a management code and a management password that are input when the transmission data is in the management state; reading out the registered transmission data when the coincidence is determined; displaying the transmission data alone, to which the input management code is assigned, when a security mode is preset for the read-out transmission data; and executing a transmission control on the basis of the transmission data that is selected from the displayed transmission data.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of an aspect of the invention.

FIG. 1 is a block diagram that schematically shows the structure of a digital multi-function peripheral (MFP) with a communication function according to the present invention;

FIG. 2 shows an example of registered data in an address book;

FIG. 3 is a flow chart illustrating an operation for registering the address book; and

FIG. 4 is a flow chart illustrating a transmission operation.

### DETAILED DESCRIPTION OF THE INVENTION

An embodiment of the present invention will now be described with reference to the accompanying drawings.

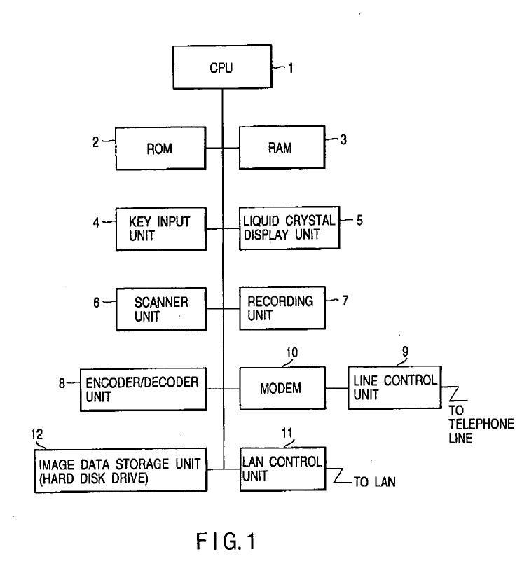

FIG. 1 schematically shows the structure of a digital multi-function peripheral (MFP) with a communication function according to the present invention. The MFP comprises a CPU 1, a ROM 2, a RAM 3, a key input unit 4, a liquid crystal display unit 5, a scanner unit 6, a recording unit 7, an encoder/decoder unit 8, a line control unit 9, a modem 10, a LAN control unit 11, and an image data storage unit 12.

The CPU 1 is a central processing unit for executing an overall control.

The ROM (Read-Only Memory) 2 stores, e.g. program data that is used by the CPU 1 in order to control the respective parts.

The RAM (Random-Access Memory) 3 stores control information at times of operations of respective parts, and an address book. The RAM 3 is backed up by, e.g. a battery so that the stored information may not be lost.

The key input unit 4 is provided with various keys for facsimile communication or Internet facsimile communication.

The liquid crystal display unit 5 effects display according to operations using the key input unit 4.

The scanner unit 6 scans an original for transmission.

The recording unit 7 prints out received data on recording paper.

The encoder/decoder unit 8 encodes image data into encoded data and decodes received encoded data into image data.

The line control unit 9 controls a telephone line, thereby to transmit a signal to a counter-part facsimile apparatus, or to receive a signal from the counter-part facsimile apparatus.

The modem 10 modulates encoded data that is delivered from the encoder/decoder 8, and outputs the modulated encoded data to the line control unit 9. In addition, the modem 10 demodulates a received signal from the counter-part facsimile apparatus, which is received via the line control unit 9.

The LAN control unit 11 is connected to a LAN (not shown) and controls e-mail transmission or e-mail reception.

The image data storage unit 12 is a hard disk drive that stores image data, etc.

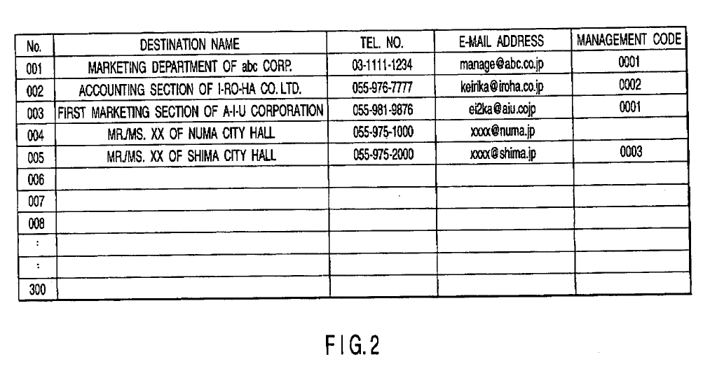

FIG. 2 shows an example of registered data in an address book in the present embodiment, although details are described later. This example adopts such a memory configuration that a department management code can be registered with a link to address information such as a destination name, a telephone number and an e-mail address. The RAM 3 can store 300 address information items at maximum.

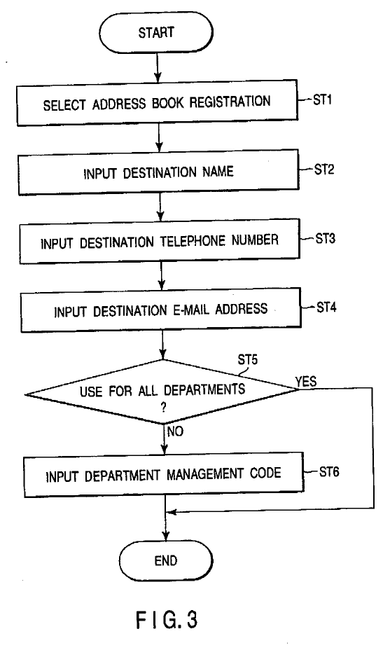

An operation for registering an address book in the RAM 3 according to the present invention will now be described with reference to a flow chart of FIG. 3.

To start with, if an operator selects address book registration through a menu screen that is displayed on the liquid crystal display unit 5 (ST1), the CPU 1 causes the liquid crystal display unit 5 to display an address book registration screen.

According to the address book registration screen displayed on the liquid crystal display unit 5, the operator inputs a destination name through the key input unit 4 (ST2), a destination telephone number (ST3) and a destination e-mail address (ST4). The CPU 1 thus registers the destination name, destination telephone number and destination e-mail address in the RAM 3.

At last, the CPU 1 causes the liquid crystal display unit 5 to effect display for prompting input of a department management code.

If the operator inputs a department management code relating to the department in which this address is used (ST5, ST6), the CPU 1 registers the input department management code in a department management code field in the RAM 3, and completes the process.

If the operator instructs the end of registration without inputting the department management code relating to the department in which the address is used (ST5), the CPU 1 assumes that this address is used in all the departments, and completes the registration process, leaving the department management code field in blank.

In the MFP according to the present invention, the security mode is set “ON” or “OFF” in advance by a serviceman, in accordance with a contract with an administrator of the MFP. Information about the ON/OFF of the security mode is stored in the RAM 3.

In addition, the administrator sets ON/OFF of the department management mode using the above-mentioned department management code in the RAM 3 in the MFP. If the department management mode is set “ON”, the MFP is set in the department management state. If the department management mode is turned “OFF”, the MFP is set in the non-department-management state in which the department management is not executed. In order to turn on the department management mode of the MFP, the administrator executes an administrator authentication operation through the key input unit 4 and turns on the department management mode by a prescribed operation. In this case, the administrator also sets a department management password, which corresponds to the department management code, in the RAM 3.

In the present invention, the access to the address book that registers address information is restricted using the above-described security mode, department management code and department management password.

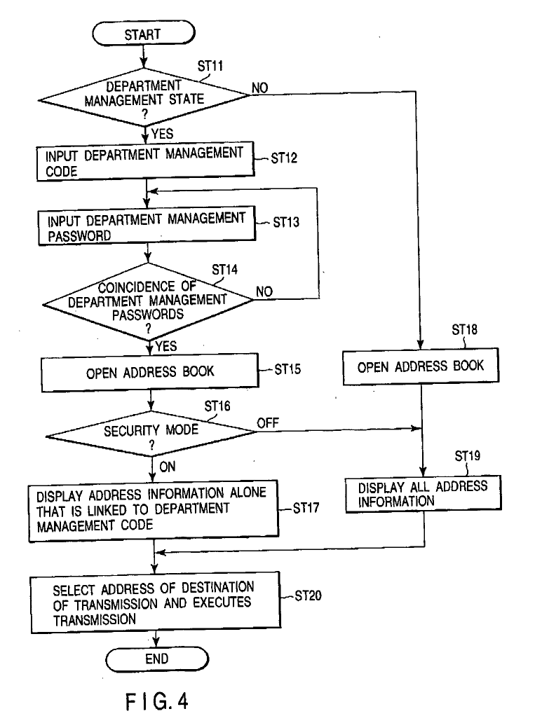

Referring to a flow chart of FIG. 4, a description is given of the transmission operation in the MFP of the present invention that has the above-described structure.

When a transmission operation is started, the CPU 1 searches the RAM 3 and checks whether the MFP is in the department management state in which the department management mode is set “ON” (ST11). The MFP is configured such that while the MFP is in the department management state, none of operations can be executed unless the department management code is input through the key input unit 4.

If the MFP is in the department management state, the CPU 1 causes the liquid crystal display unit 5 to display a screen for prompting input of the department management code and department management password.

The operator inputs the department management code of the destination of transmission through the key input unit 4, and then inputs the department management password.

If the department management code is input and the department management password is input (ST12, ST13), the CPU 1 checks whether the department management password, which corresponds to the department management code stored in the RAM 3, coincides with the input department management password (ST14).

If the department management passwords are non-coincident (ST14), the CPU 1 causes the liquid crystal display unit 5 to display once again a screen for prompting input of the department management password (ST13).

If the department management passwords are coincident (ST14), the CPU 1 opens the address book that is registered in the RAM 3 (ST15).

In this case, if the security mode that is set in the RAM 3 of the MFP is in the “ON” state, the CPU 1 causes the liquid crystal display unit 5 to display only address information that is linked to the associated department management code (ST17).

For example, in the case where the address book shown in FIG. 2 is registered, if a department management code “0001” is input, the CPU 1 causes the liquid crystal display unit 5 to display items No. 001, No. 003 and No. 004 in the address book.

If the security mode that is set in the RAM 3 of the MFP is in the “OFF” state, the CPU 1 causes the liquid crystal display unit 5 to display all address information (ST19).

Besides, in step ST11, if the MFP is in the non-department-management state in which the department management mode is turned off, the CPU 1 opens the address book that is registered in the RAM 3 (ST18) and causes the liquid crystal display unit 5 to display all address information (ST19).

For example, in the case where the address book shown in FIG. 2 is registered, the CPU 1 causes the liquid crystal display unit 5 to display all address information of items No. 001 to No. 005.

The operator selects the address of the destination of transmission using the key input unit 4.

When the address of the destination of transmission is selected, the CPU 1 controls the operation for transmission to the selected address (ST20).

As has been described above, in the present embodiment, if the security mode is set “ON”, the address information associated with other departments can neither be displayed on the liquid crystal display unit 5, nor be used. It is possible to prevent the address information from leaking out to other departments or a third party.

In the present embodiment, the use of the address book at the time of transmission is exemplified. In a case where there is provided a function of printing out the address book in a list format from the recording unit 7, it is possible to adopt such a configuration that only address information that is linked to a department management code input from the key input unit 4 may be printed at the time of a list printing operation.

The security mode may be configured to be turned on/off by a special operation that is executed by the administrator of the MFP using the key input unit 4.

It is possible to adopt such a configuration as to prevent image data stored in the hard disk drive 12 from leaking out due to a theft of the hard disk drive 12. For example, in the case of an MFP that can optionally be equipped with a scrambler board for encrypting data in the hard disk drive, the security mode may be turned on when the scrambler board is mounted and the security mode may be turned off when the scrambler board is not mounted.

In the above-described embodiment, the address information is explained by way of example. Similarly, communication history information may be stored in the RAM 3 to ensure the security thereof.

As has been described above, according to the embodiment of the present invention, the user, who wishes to place importance on the security of address information or communication history information as confidential information, may turn on the security mode. Thereby, the use of address information can be restricted on a department-by-department basis, or the access to communication history information can be restricted.

On the other hand, a user, who is not required to treat address information or communication history information as confidential information, may turn off the security mode. Thereby, the user is free from the restrictions on the use of address information on a department-by-department basis, or on the access to communication history information. Thus, an ordinary easy-to-use MFP can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of transmitting data for a communication terminal apparatus that is connected to a plurality of terminal devices and has a function of transmitting data to the terminal devices, the method comprising:
assigning a management code to each of transmission data that are to be transmitted to said plurality of terminal devices, and pre-registering a management password corresponding to the management code;
confirming a management state of the registered transmission data when the data is to be transmitted from the communication terminal apparatus;
determining coincidence/noncoincidence between the registered management password corresponding to the management code and a management code and a management password that are input when the transmission data is in the management state;
reading out the registered transmission data when the coincidence is determined;
displaying the transmission data alone, to which the input management code is assigned, when a security mode is preset for the read-out transmission data; and
executing a transmission control on the basis of the transmission data that is selected from the displayed transmission data.

2. The method of transmitting data for a communication terminal apparatus, according to claim 1, wherein the transmission data is address information including a facsimile number or an e-mail address relating to the terminal device at a destination of transmission.

3. The method of transmitting data for a communication terminal apparatus, according to claim 1, wherein the pre-registered transmission data are all displayed if the transmission data are not in the management state.

4. The method of transmitting data for a communication terminal apparatus, according to claim 1, wherein the read-out transmission data are all displayed if the security mode is not preset for the read-out transmission data.

5. The method of transmitting data for a communication terminal apparatus, according to claim 1, wherein the security mode is preset by an administrator of the communication terminal apparatus or a serviceman.

6. The method of transmitting data for a communication terminal apparatus, according to claim 1, wherein the security mode is turned on when a hardware board, which is mountable on the communication terminal apparatus, is mounted, and is turned off when the hardware board is not mounted.

7. A method of transmitting data for an image forming apparatus that is connected to a plurality of terminal devices and has a function of transmitting image data to the terminal devices, the method comprising:
assigning a management code to each of transmission data that are to be transmitted to said plurality of terminal devices, and pre-registering a management password corresponding to the management code;
confirming a management state of the registered transmission data when the image data is to be transmitted from the image forming apparatus;
determining coincidence/noncoincidence between the registered management password corresponding to the management code and a management code and a management password that are input when the transmission data is in the management state;
reading out the registered transmission data when the coincidence is determined;
displaying the transmission data alone, to which the input management code is assigned, when a security mode is preset for the read-out transmission data; and
executing a transmission control on the basis of the transmission data that is selected from the displayed transmission data.

8. The method of transmitting data for an image forming apparatus, according to claim 7, wherein the transmission data is address information including a facsimile number or an e-mail address relating to the terminal device at a destination of transmission.

9. The method of transmitting data for an image forming apparatus, according to claim 7, wherein the pre-registered transmission data are all displayed if the transmission data are not in the management state.

10. The method of transmitting data for an image forming apparatus, according to claim 7, wherein the read-out transmission data are all displayed if the security mode is not preset for the read-out transmission data.

11. The method of transmitting data for an image forming apparatus, according to claim 7, wherein the security mode is preset by an administrator of the image forming apparatus or a serviceman.

12. The method of transmitting data for an image forming apparatus, according to claim 7, wherein the security mode is turned on when a hardware board, which is mountable on the image forming apparatus, is mounted, and is turned off when the hardware board is not mounted.
